(19) United States
(12) Patent Application Publication
(10) Pub. No.: US 2010/0172629 A1
(43) Pub. Date: Jul. 8, 2010

(54) REPRODUCTION SIGNAL PROCESSING DEVICE AND VIDEO DISPLAY DEVICE

(76) Inventors: Yoshinori Shirakawa, Osaka (JP); Akira Yamamoto, Osaka (JP)

Correspondence Address: MCDERMOTT WILL & EMERY LLP, 600 13TH STREET, NW, WASHINGTON, DC, 20005-3096, US

(21) Appl. No.: 12/066,207

(22) PCT Filed: Jun. 19, 2007
(86) PCT No.: PCT/JP2007/062332

§ 371 Date: Mar. 7, 2008

(30) Foreign Application Priority Data
Nov. 29, 2006 (JP) 2006-322115

(51) Int. Cl. H04N 5/95

(52) U.S. Cl. 386/85; 386/E05.037

(57) ABSTRACT

A reproduction signal processing device employing a fully digital timing recovery scheme, which obtains asynchronous digital data with the sampling clock of the A/D converter being asynchronous with the channel clock, wherein an A/D converter 102 converts the input analog signal to asynchronous digital data based on an asynchronous clock of a clock generator 103. A baseline controller 105 generates, at a pseudo-synchronous data generator 1051 therein, pseudo-synchronous data based on the asynchronous digital data from the A/D converter 102 and timing error information and a pseudo-synchronous clock from a timing detector 104. An the offset component calculator 1053 calculates an offset component for the pseudo-synchronous data, and subtracts the offset component at the subtractor 1050. Thus, the offset component contained in the asynchronous digital data is precisely removed.

### TECHNICAL FIELD

The present invention relates to a reproduction signal processing device for removing an offset component from a signal read out from a recording medium such as an optical disc to reproduce data, and a video display device including such a reproduction signal processing device.

### BACKGROUND ART

With some conventional reproduction signal processing devices for reproducing signals read out from a recording medium such as an optical disc, the readout input RF signal is input to an A/D converter, and the sampling clock of the input RF signal in the A/D converter is synchronized with the channel clock of the input RF signal, wherein the input RF signal is sampled with the synchronized sampling clock to obtain a digital signal. In the prior art, in order to synchronize the sampling clock in the A/D converter with the channel clock of the input RF signal, a digital circuit is used to detect a frequency error or a phase error from the digital signal obtained by the A/D converter, and the generation of the sampling clock at the clock generator, being an analog circuit, is controlled in feedback control to thereby obtain the synchronized sampling clock. Thus, the conventional timing recovery scheme has been an analog and digital scheme.

With a reproduction signal processing device of such an analog and digital timing recovery scheme, an offset component is removed from the synchronous data sampled with the synchronous clock that is synchronized with the channel clock of the input RF signal to thereby precisely reproduce data, as described in Patent Document 1, for example.

The fully digital timing recovery scheme has been known in the art as a scheme with a better response than the analog and digital timing recovery scheme. With a reproduction signal processing device of such a fully digital timing recovery scheme, the sampling clock of the A/D converter is asynchronous with the channel clock, the data read out from the recording medium is asynchronously sampled by the A/D converter, and the asynchronously sampled data is converted to synchronous data by means of only within a digital circuit.

Patent Document 1: Japanese Laid-Open Patent Publication No. 2001-195830

### DISCLOSURE OF THE INVENTION

### Problems to be Solved by the Invention

With a reproduction signal processing device of the fully digital timing recovery scheme, however, when one attempts to adjust/control the baseline by removing the offset component contained in the sampled data from the A/D converter, it becomes necessary to remove the offset component from the asynchronously sampled data from the A/D converter, as with the analog and digital timing recovery scheme. While the offset component remover (i.e., a baseline controller) is a kind of high-pass filtering, since the channel clock and the sampling clock are not synchronized with each other, the frequency characteristic of the high-pass filter varies significantly depending on the clock frequency ratio between the channel clock and the sampling clock. Therefore, a frequency region that should be cut off may not be cut off, and a frequency region that should not be cut off may be cut off, thereby failing to realize an appropriate offset component removal.

It is an object of the present invention to provide a reproduction signal processing device employing a fully digital timing recovery scheme, capable of always appropriately removing the offset component from the asynchronously sampled data from the A/D converter, irrespective of the clock frequency ratio between the channel clock and the sampling clock.

### Means for Solving the Problems

In order to achieve the object set forth above, the present invention performs a removal of the offset component from the asynchronously sampled data from the A/D converter, in which the asynchronously sampled data from the A/D converter is converted to synchronous data in advance, after which the offset component is removed from the synchronous data.

Specifically, a reproduction signal processing device of the present invention is a reproduction signal processing device for reproducing data and a data recording timing from a readout signal including data information and data recording timing information read out from a recording medium; a clock generator for generating and outputting an asynchronous clock that is not necessarily synchronized with the data recording timing; an analog-digital converter for digitalizing the readout signal from the recording medium based on the asynchronous clock to output asynchronous data; an offset component remover for calculating an offset component contained in the asynchronous data and removing the offset component from the asynchronous data; and a timing detector for generating timing error information representing a timing error between the data recording timing and the asynchronous clock of the clock generator, and outputting a pseudo-synchronous clock that is synchronized or pseudo-synchronized with the data recording timing based on the timing error information, wherein the offset component remover includes: a subtractor for subtracting the offset component calculated by the offset component remover from the asynchronous data of the analog-digital converter; a pseudo-synchronous data generator for generating pseudo-synchronous data that is synchronized with the pseudo-synchronous clock based on the timing error information of the timing detector and the asynchronous data; and an offset component calculator for calculating an offset component contained in the pseudo-synchronous data and outputting the calculated offset component to the subtractor.

In one embodiment of the reproduction signal processing device of the present invention, the timing detector outputs a lock signal when a frequency and phase of the asynchronous data have been pulled in; and the offset component remover further includes a mode selector, which selects the asynchronous data from the analog-digital converter in a beginning of an operation and thereafter selects the pseudo-synchronous data of the pseudo-synchronous data generator after receiving the lock signal of the timing detector.

In one embodiment of the reproduction signal processing device of the present invention, the clock generator generates and outputs a fixed-frequency clock.

In one embodiment of the reproduction signal processing device of the present invention, the clock generator generates an asynchronous clock whose frequency is equal to, higher than or lower than a frequency of the data recording timing contained in the readout signal.

In one embodiment of the reproduction signal processing device of the present invention, the asynchronous data from the analog-digital converter is a DC-free signal.

In one embodiment of the reproduction signal processing device of the present invention, the pseudo-synchronous data generator generates the pseudo-synchronous data by using the timing error information generated by the timing detector as phase information.

In one embodiment of the reproduction signal processing device of the present invention, the pseudo-synchronous data generator generates the pseudo-synchronous data by linearly interpolating two adjacent asynchronous data based on the timing error information generated by the timing detector.

In one embodiment of the reproduction signal processing device of the present invention, the pseudo-synchronous data generator generates the pseudo-synchronous data through a Nyquist interpolation between two adjacent asynchronous data based on the timing error information generated by the timing detector.

In one embodiment of the reproduction signal processing device of the present invention, the pseudo-synchronous data generator generates the pseudo-synchronous data by fixing the data to different specific values for a positive polarity and for a negative polarity based on a polarity of a sign of the asynchronous data.

In one embodiment of the reproduction signal processing device of the present invention, phase information, being the timing error information generated by the timing detector, is a timing error occurring between the asynchronous data and the pseudo-synchronous data.

In one embodiment of the reproduction signal processing device of the present invention, the readout signal read out from the recording medium is supplied via a wireless transmission path or a transmission path including an optical fiber, a coaxial cable or a power line.

In one embodiment of the reproduction signal processing device of the present invention, the recording medium is an optical disc including a DVD, a CD or a Blu-ray disc.

A video display device of the present invention is a video display device, including: an LSI, including the reproduction signal processing device of claim 1 and a signal processing circuit for decoding a received signal including audio data and video data based on the pseudo-synchronous data from which the offset component has been removed, as obtained by the reproduction signal processing device; and a display terminal for receiving the decoded signal from the LSI to audibly output decoded audio data and display decoded video data.

Thus, according to the present invention, although the digital data output from the analog-digital converter (A/D converter) is data that is not synchronized with the data recording timing information read out from the recording medium (i.e., the channel clock), the asynchronous data is converted by the pseudo-synchronous data generator to pseudo-synchronous data whose frequency and phase are substantially matched with those of the synchronous data based on the pseudo-synchronous clock and the timing error information generated in the timing detector, and then the offset component is removed from the pseudo-synchronous data by the offset component remover. Therefore, the offset component remover (i.e., the high-pass filter) can be fixedly set to the frequency characteristic corresponding to the synchronous data sampled with the channel clock, and is capable of desirably performing the offset removal.

Particularly, in the present invention, when the frequency and phase of the asynchronous data have been pulled in, the timing detector outputs a lock signal at this point in time, and the mode selector selects the pseudo-synchronous data from the pseudo-synchronous data generator to output the selected data to the offset component remover, whereby it is possible to precisely remove the offset component from the pseudo-synchronous data whose frequency and phase have been pulled in.

### EFFECTS OF THE INVENTION

As described above, the present invention provides a reproduction signal processing device employing a fully digital timing recovery scheme, capable of precisely removing the offset even if the digital signal from the A/D converter is asynchronous data that is not synchronized with the channel clock.

### BRIEF DESCRIPTION OF THE DRAWINGS

FIG. 1 is a schematic diagram showing a general configuration of a reproduction signal processing device according to Embodiment 1 of the present invention.

FIG. 2 is a diagram showing a detailed configuration of the reproduction signal processing device.

FIG. 3 is a diagram illustrating DC-free codes according to the embodiment.

FIG. 4 is a diagram showing a clock of a higher frequency than the channel clock and a clock of a lower frequency than the channel clock.

FIG. 5(a) is a diagram illustrating a DC offset component contained in the readout signal from the recording medium, and FIG. 5(b) is a diagram illustrating a lower frequency component.

FIG. 6 is an operation state diagram of a timing detector provided in the reproduction signal processing device.

FIG. 7 is a diagram showing sync patterns recorded on a DVD.

FIG. 8 shows overflow values are calculated by the timing detector provided in the reproduction signal processing device.

FIG. 9 is a diagram illustrating the pseudo-synchronous clock generated by the timing detector.

FIG. 10 is a diagram illustrating an operation of a pseudo-synchronous data generator provided in the reproduction signal processing device.

FIG. 11 is a diagram illustrating another operation of the pseudo-synchronous data generator.

FIG. 12 is a diagram showing an internal configuration of an offset component calculator provided in the reproduction signal processing device.

FIG. 13 is a schematic diagram showing a general configuration of a video display device including a reproduction signal processing device of the present invention.

FIG. 14 is a schematic diagram showing a general configuration of another video display device including a reproduction signal processing device of the present invention.

### DESCRIPTION OF REFERENCE NUMERALS

100 Reproduction signal processing device
1050 Subtractor
1053b Adder
1053d Amplifier
201 Recording medium
202 Pickup
301 Transmission line

### BEST MODE FOR CARRYING OUT THE INVENTION

Embodiments of the present invention will now be described with reference to the drawings.

### EMBODIMENT 1

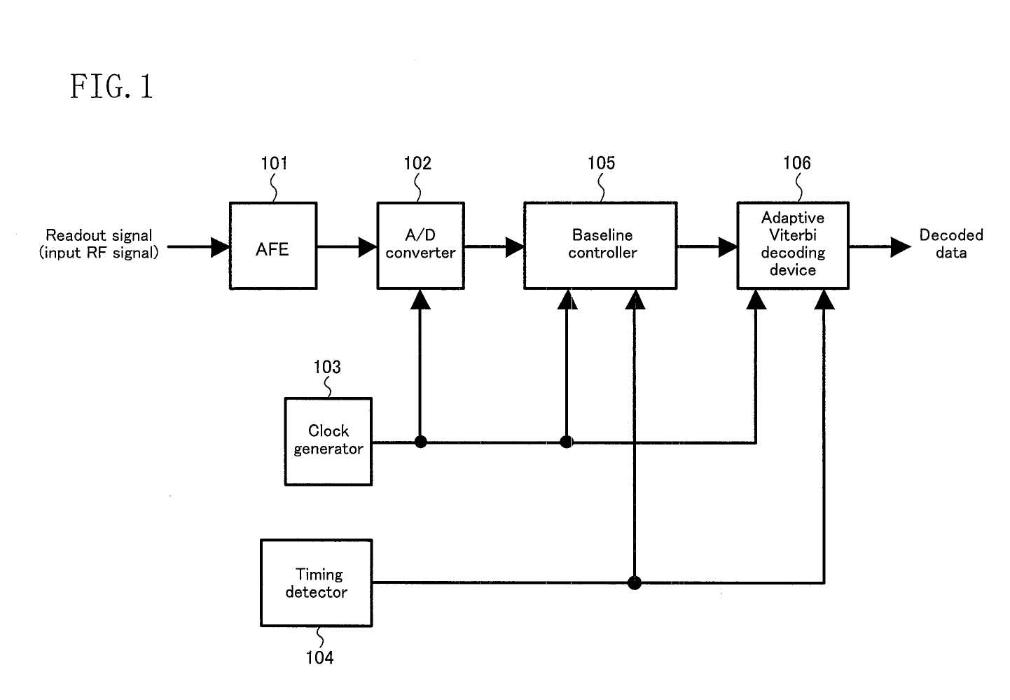

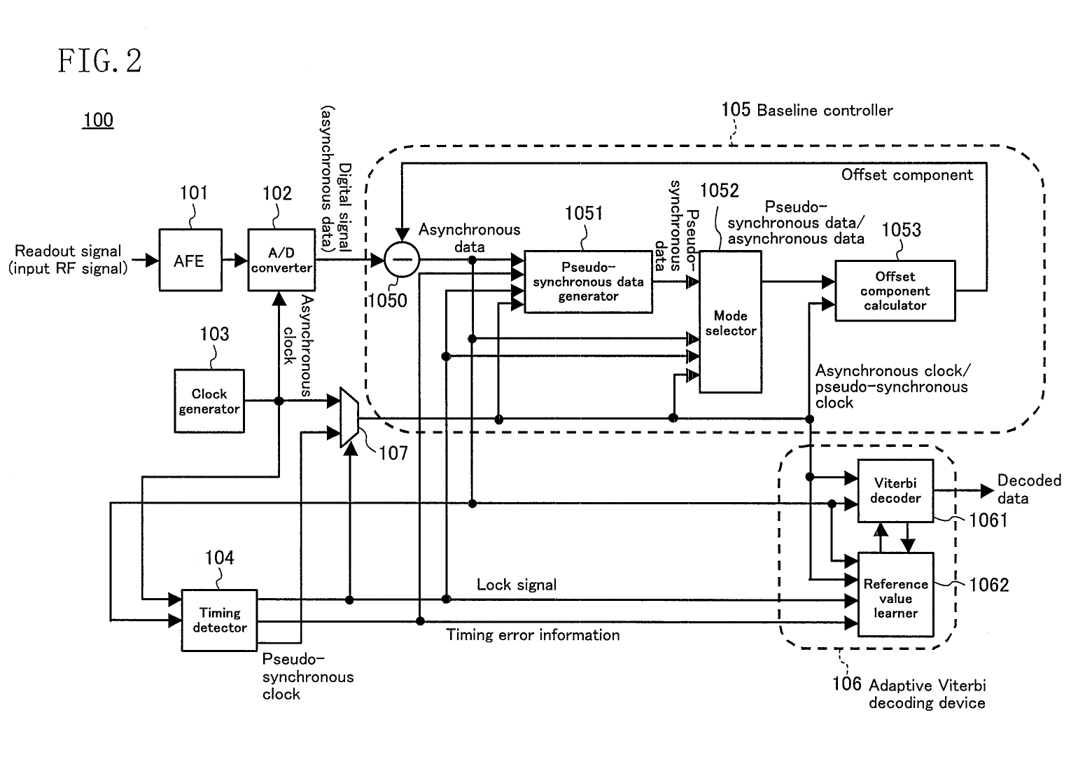

FIGS. 1 and 2 schematically show a general configuration of a reproduction signal processing device according to Embodiment 1 of the Present Invention.

A reproduction signal processing device 100 of the present invention performs a reproduction signal process of reading out data recorded on a recording medium such as a DVD and decoding the readout data, and includes an AFE (Analog Front End) 101, an A/D converter (analog/digital converter) 102, a clock generator 103, a timing detector 104, a baseline controller (offset component remover) 105, and an adaptive Viterbi decoding device 106, as shown in FIGS. 1 and 2.

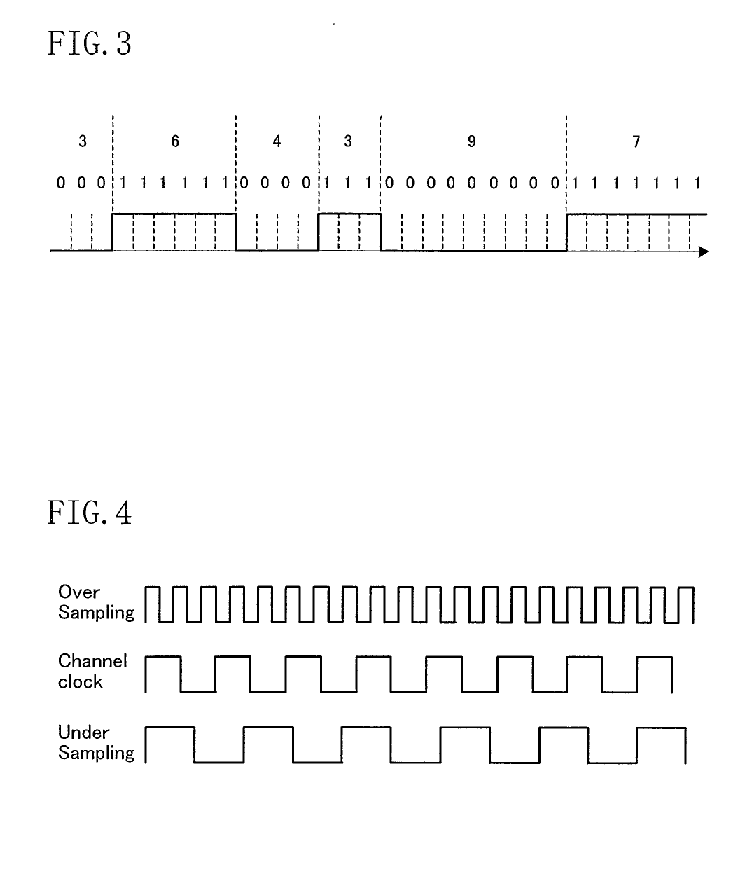

First, the DC-free code, which is one characteristic of codes on a CD or a DVD will be described with reference to FIG. 3, as an example of digital data recorded on a recording medium.

As shown in FIG. 3, digital data consisting of 0′s and 1′s is recorded on a recording medium. With a CD or a DVD, the clock is embedded in the data itself, whereby the pattern of 0′s and 1′s has some regularities, one of which is what is called “DC-free”. This means that the number of 0′s and the number of 1′s are equal to each other over a sufficiently long block, i.e., the average sum of data is 0, where the value of 0 is assumed to be −1. Then, it is known that when data is reproduced, no DC (direct current) component is supposed to be contained in the reproduced data, which can be utilized in performing the waveform shaping.

The present invention is characterized in that the baseline control can be performed not only by using synchronous data sampled with a sampling clock that is synchronized with the channel clock of the input signal, but also by using asynchronous data that is not synchronized with the channel clock.

Next, referring to FIG. 2, a detailed configuration of the reproduction signal processing device of the present embodiment will be described. The readout signal read out from the recording medium contains data information and channel clock information (the data recording timing information), and the readout signal is read by an optical pickup or a magnetic head (not shown) to be an analog signal. The analog signal is subjected to waveform shaping through the AFE 101, and then converted to a digital signal through the A/D converter 102 using the sampling clock generated by the clock generator 103. As shown in FIG. 4, the sampling clock generated by the clock generator 103 may be a fixed asynchronous clock having an oversampling frequency that is higher than the channel clock, or a fixed asynchronous clock having an undersampling frequency that is lower than the channel clock. Alternatively, it may be a fixed clock of an equal frequency to that of the channel clock.

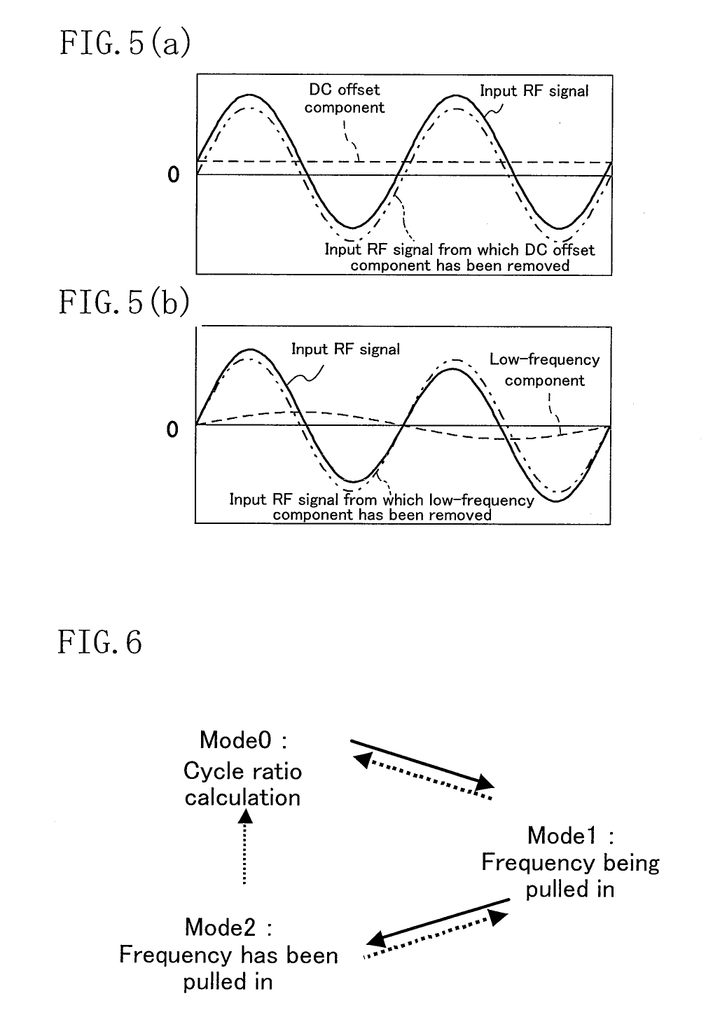

The digital signal converted through the A/D converter 102 is input to the baseline controller 105. The baseline controller 105 is provided for shaping the waveform to an ideal waveform by removing an unwanted frequency component, e.g., a DC offset component as shown in FIG. 5(a), or a low-frequency component as shown in FIG. 5(b) due to the deflection of the recording medium, etc., in a case where the waveform shaping cannot sufficiently be performed by the AFE 101 due to various factors such as differences in recording characteristics among different data recording apparatuses, variations among recording mediums and variations in the characteristics of the AFE 101.

The output of the baseline controller 105 is input to the adaptive Viterbi decoding device 106, which outputs decoded data. As shown in FIG. 2, the adaptive Viterbi decoding device 106 includes a Viterbi decoder 1061, and a reference value learner 1062 for learning the reference value to be referred to by the Viterbi decoder 1061.

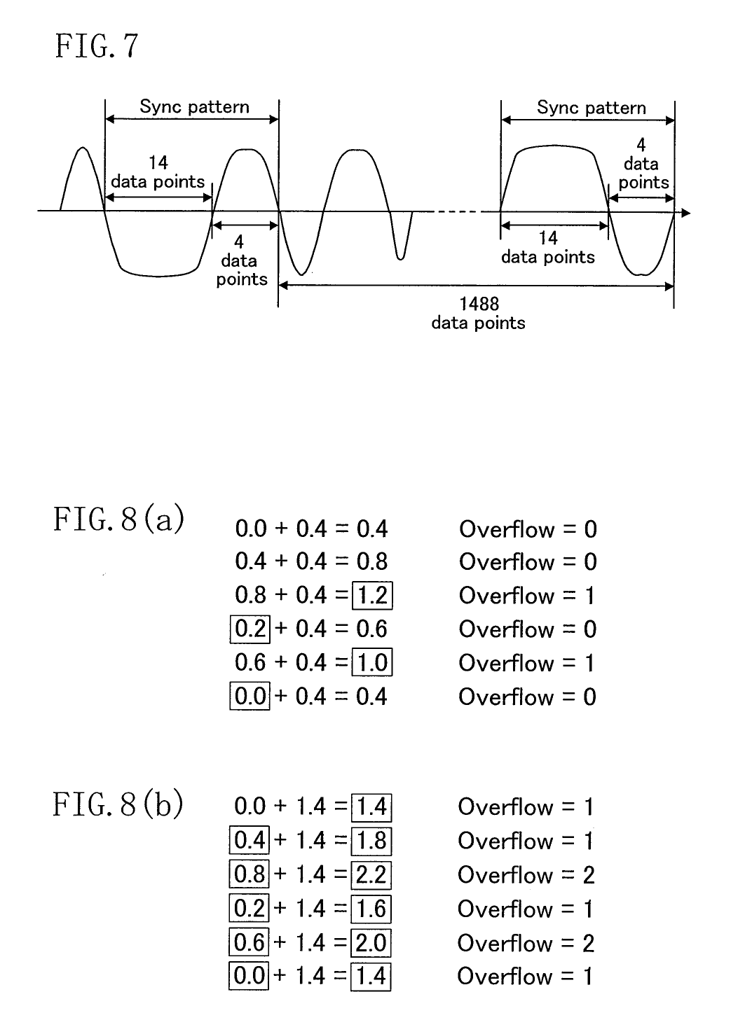

Next, before describing the internal configuration of the baseline controller 105, the configuration of the timing detector 104 will be described. Although the internal configuration of the timing detector 104 is not shown in the drawings, the general configuration thereof is as follows. First, as shown in FIG. 6, there are three modes of operation, i.e., Mode 0 in which the cycle ratio between the channel clock and the asynchronous clock of the clock generator 103 is calculated; Mode 1 in which a frequency pull-in operation is performed to obtain pseudo-synchronous data from asynchronous data; and Mode 2 in which the frequency pull-in operation has been completed. In Cycle Ratio Calculation Mode 0, the sync pattern of a DVD, for example, is used as shown in FIG. 7. A sync pattern is a combination of 14 data points being positive (or negative) between two adjacent zero-crossing points in the channel clock and 4 data points being negative (or positive) between two adjacent zero-crossing points, and one sync pattern is recorded for every 1488 data points in the channel clock. The sync pattern is detected by a ratio of 14:4 in the asynchronous clock of the clock generator 103. Then, the cycle ratio between the channel clock and the asynchronous clock of the clock generator 103 is calculated in terms of the ratio between the data count in the asynchronous clock between two sync patterns and 1488. For example, where the asynchronous clock of the clock generator 103 is of a higher frequency than the channel clock, if the oversampling factor is 2.5, the cycle ratio will be 0.4 (=1/2.5). Moreover, where the asynchronous clock is of a lower frequency than the channel clock, if the undersampling factor is 0.71, the cycle ratio will be 1.4 (=1/0.71).

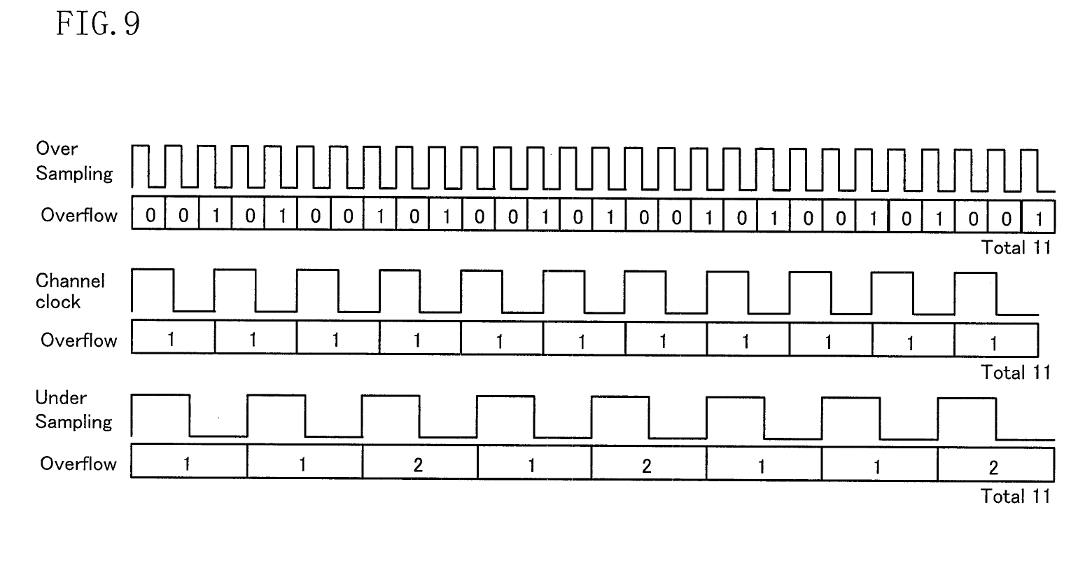

Next, in Frequency Pull-in Mode 1, first, the process repeatedly adds the cycle ratio calculated in Mode 0 described above for every rising edge of the asynchronous clock to obtain an overflow value as being the integral portion of the sum for each addition result while obtaining timing error information as being the decimal portion of the sum. For example, where the cycle ratio is 0.4 as shown in FIG. 8(a), when the addition result is 1.2, for example, the overflow value is the integral portion thereof being 1, and the timing error information is the decimal portion thereof being 0.2. Then, at the next rising edge of the asynchronous clock, the cycle ratio (=0.4) is added to a value (=0.2) obtained by subtracting the integral portion (=1) from the addition result (=1.2) to thereby obtain the addition result (=0.6). Where the cycle ratio is 1.4 as shown in FIG. 8(b), when the addition result is 1.6, for example, the overflow value is the integral portion thereof being 1, and the timing error information is the decimal portion thereof being 0.6. Then, at the next rising edge of the asynchronous clock, the cycle ratio (=1.4) is added to a value (=0.6) obtained by subtracting the integral portion (=1) from the addition result (=1.6) to thereby obtain the addition result (=2.0), whereby the overflow value is the integral portion thereof being 2, and the timing error information is the decimal portion thereof being 0.0. The overflow value obtained as described above can be used as follows. In the case of oversampling where the cycle ratio over 1, the frequency of the pseudo-synchronous clock can be matched with that of the channel clock by making the pseudo-synchronous clock rise each time the overflow value is equal to 1, as shown in FIG. 9. In the case of undersampling where the cycle ratio is under 1, the frequency of the pseudo-synchronous clock can be matched with that of the channel clock by making the pseudo-synchronous clock rise once each time the overflow value is equal to 1 and twice each time the overflow value is equal to 2, as shown in FIG. 9. Thus, the pseudo-synchronous clock and the timing error information are generated based on the integral portion and the decimal portion of the overflow value. After the pseudo-synchronous clock is generated as described above, the number of data points between two consecutive sync patterns is counted by using the pseudo-synchronous clock to confirm that the count is equal to 1488 over a predetermined number of iterations. After the confirmation, the process transitions to Post-Frequency Pull-in Mode 2.

In Post-Frequency Pull-in Mode 2, the process outputs a lock signal, which indicates that the frequency pull-in operation has been completed, and fine-tunes the phase while precisely calculating the cycle ratio.

Next, the internal configuration of the baseline controller 105 will be described with reference to FIG. 2. The baseline controller 105 includes therein a subtractor 1050, a pseudo-synchronous data generator 1051, a mode selector 1052, and an offset component calculator 1053.

The subtractor 1050 receives the digital signal from the A/D converter 102. The pseudo-synchronous data generator 1051 receives the signal of subtraction result from the subtractor 1050 and the timing error information and the lock signal from the timing detector 104, and selectively receives, via a selector 107, the pseudo-synchronous clock from the timing detector 104 or the asynchronous clock from the clock generator 103. The selector 107 selects the asynchronous clock of the clock generator 103 when the lock signal of the timing detector 104 is not received, and selects the pseudo-synchronous clock from the timing detector 104 when the lock signal is received.

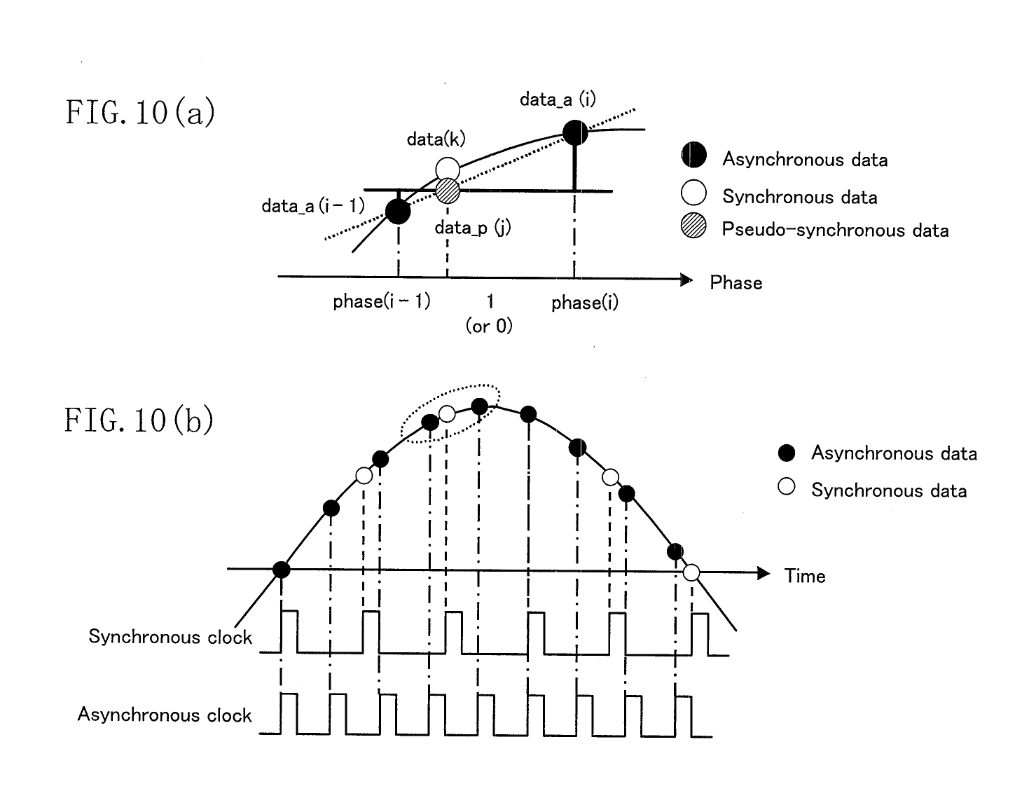

The pseudo-synchronous data generator 1051 generates the pseudo-synchronous data based on the asynchronous data from the subtractor 1050, the timing error information from the timing detector 104 and the pseudo-synchronous clock from the selector 107, only after receiving the lock signal from the timing detector 104. The details of the generation process will now be described. FIG. 10(a) is an enlarged view showing a portion of FIG. 10(b) that is delimited by a broken line. In FIGS. 10(a) and 10(b), solid circles represent asynchronous data, open circles represent supposed synchronous data, and hatched circles represent pseudo-synchronous data obtained from the asynchronous data. As can be seen from FIG. 10(b), the high-frequency asynchronous clock is shifted from the synchronous clock. Therefore, the asynchronous data data_a(i−1) is shifted from the synchronous data data(k) by the phase phase(I−1), and the asynchronous data data_a(i) is shifted from the synchronous data data(k) by the phase phase(i), as shown in FIG. 10(a). Note however that in FIG. 10(a), the phase is normalized so that the phase is from 0 to 1, instead of from 0 to 2π.

The pseudo-synchronous data generator 1051 approximates the phase-shifted asynchronous data to the synchronous data so that the state of the synchronous data is similar to that used by the reproduction signal processing device 100, by calculating the pseudo-synchronous data data_p(j) through a linear approximation with two asynchronous data data_a(I−1) and data_a(i) as shown in FIG. 10(a), based on Expression 1 below.

$$phase ( i ) \text{:} phase ( i - 1 ) - 1 = ( \begin{matrix}data\_p ( j ) - \\ data\_a ( i )\end{matrix} ) \text{:} ( \begin{matrix}data\_p ( j ) - \\ data\_a ( i - 1 )\end{matrix} ) \\ data\_p ( j ) = \frac{\begin{matrix}data\_a ( i - 1 ) \times phase ( i ) - \\ data\_a ( i ) \times phase ( i - 1 )\end{matrix}}{phase ( i ) - ( phase ( i - 1 ) - 1 )} \qquad [ Expression 1 ]$$

In Expression 1 above, data_a(i) and data_a(I−1) each denote asynchronous data from the subtractor 1050, being data sampled with the asynchronous clock of the clock generator 103. Moreover, phase(i) and phase(I−1) each denote a phase, for which the timing error information from the timing detector 104 is used.

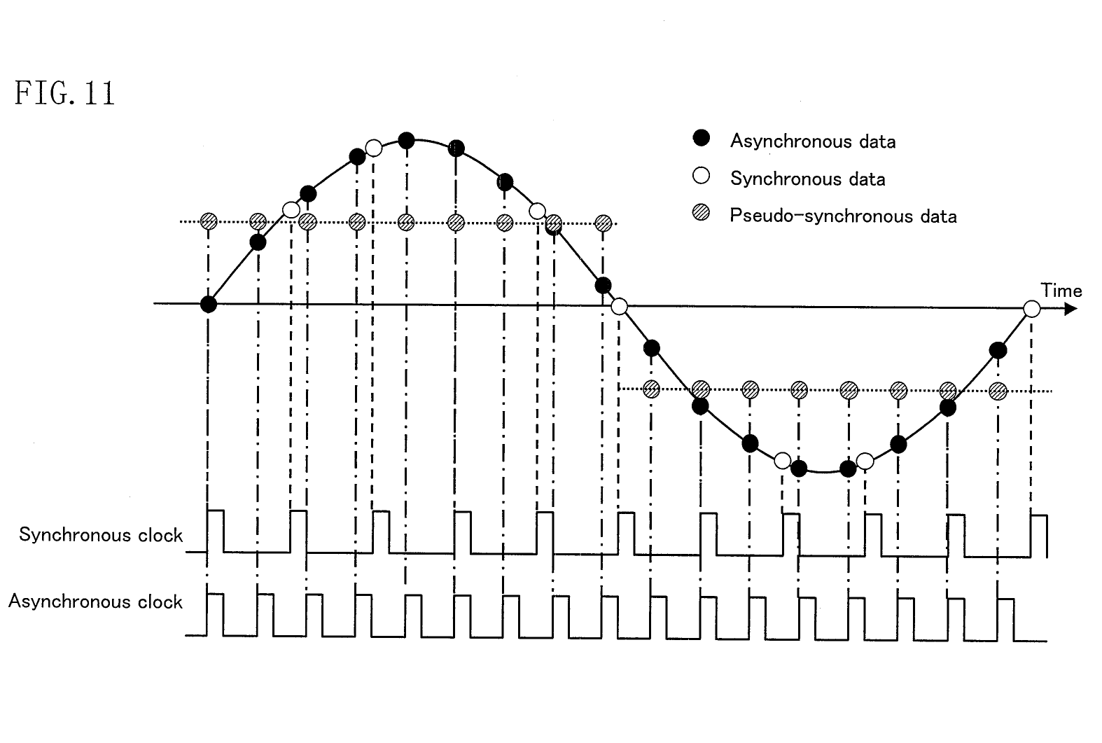

While the pseudo-synchronous data data_p(j) is obtained by linear approximation based on Expression 1 above in the present embodiment, it may be obtained by Nyquist interpolation. Furthermore, it may be obtained by other simpler approximation methods, e.g., a method based on the polarity of the sign of the asynchronous data, in which every pseudo-synchronous data point is fixed to a particular positive value if the polarity of that data point is positive and every pseudo-synchronous data point is fixed to a particular negative value if the polarity of that data point is negative, as shown in FIG. 11.

The mode selector 1052 provided in the baseline controller 105 shown in FIG. 2 selects and outputs the asynchronous data from the subtractor 1050 before the lock signal from the timing detector 104 is received, i.e., in the unlocked state before the frequency and phase of the asynchronous data have been pulled in, whereas the mode selector 1052 selects the pseudo-synchronous data from the pseudo-synchronous data generator 1051 and outputs the selected data by using the pseudo-synchronous clock from the timing detector 104 in the locked state in which the lock signal from the timing detector 104 is received. Thus, there is obtained a signal similar to that which would supposedly be obtained with the synchronous clock.

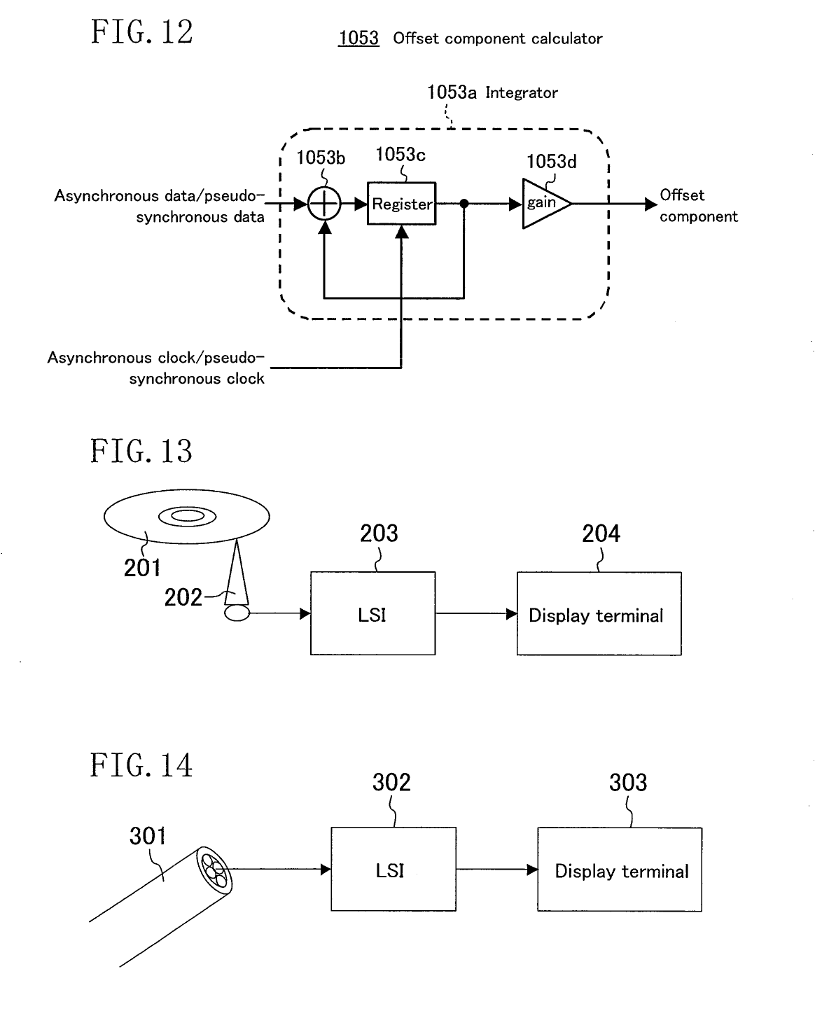

As shown in FIG. 12, the offset component calculator 1053 provided in the baseline controller 105 is an integrator 1053a for detecting a DC offset component or a lower frequency component of the pseudo-synchronous data of the pseudo-synchronous data generator 1051 or the asynchronous data received from the A/D converter 102 via the subtractor 1050. The integrator 1053a includes an adder 1053b which receives the pseudo-synchronous data or the asynchronous data as selected by the mode selector 1052, a register 1053c for storing the output from the adder 1053b, and an amplifier 1053 for amplifying, by a predetermined factor, the output signal from the register 1053c, wherein the output signal from the register 1053c is added to the pseudo-synchronous data or the asynchronous data at the adder 1053b. The offset component calculator 1053 being the integrator 1053a can be said to be a low-pass filter of a particular frequency, and the offset component is a low-frequency component.

The offset component calculated by the offset component calculator 1053 is input to the subtractor 1050 provided in the baseline controller 105, and is subtracted from the asynchronous data from the A/D converter 102, as shown in FIG. 2. Since the offset component is a low-frequency component, and this is subtracted from the asynchronous data, the subtraction result sent to the adaptive Viterbi decoding device 106 will be data that has been filtered through a high-pass filter.

FIG. 13 shows a video display device including an LSI with the present reproduction signal processing device provided therein. The video display device includes an LSI 203 including a signal processing circuit for performing waveform equalization, error correction, control, modulation, decoding, data extraction, etc., by using a reproduction signal waveform read out from a recording medium 201 such as an optical disc by means of a laser beam of a pickup 202, and a display terminal 204 for audibly outputting analog or digital audio data and displaying video data based on the decoded reproduction signal output from the LSI 203.

FIG. 14 shows another video display device including an LSI with the present reproduction signal processing device provided therein. The video display device includes an LSI 302 including a signal processing circuit for performing waveform equalization, error correction, control, modulation, decoding, data extraction, etc., by using a reproduction signal waveform read out from a transmission line 301 such as a coaxial cable, and a display terminal 303 for audibly outputting analog or digital audio data and displaying video data based on the decoded reproduction signal output from the LSI 302.

Alternatively, the present invention may be a program to be used with a computer, which instructs the computer to implement the functions of some or all of the means, devices, elements, circuits, etc., of the reproduction signal processing device as set forth above. The present invention may also be a computer-readable recording medium storing such a program.

In one embodiment, the program may be used with a computer by being stored in a computer-readable recording medium. In another embodiment, the program may be used with a computer by being transmitted through a transmission medium and read by the computer. The recording medium includes a ROM, or the like, and the transmission medium includes transmission media such as the Internet, light, radio waves, sound waves, etc.

Moreover, the computer is not limited to pure hardware such as a CPU, but may include firmware, OSes and even peripheral devices.

As described above, the configuration of the present invention may be implemented as software or hardware.

### INDUSTRIAL APPLICABILITY

As described above, the present invention is capable of effectively removing an offset component or a lower frequency component contained in asynchronous data and performing signal processes with a high stability, and is therefore suitable for use in a reproduction signal processing device employing a fully digital timing recovery scheme.

1. A reproduction signal processing device for reproducing data and a data recording timing from a readout signal including data information and data recording timing information read out from a recording medium;
a clock generator for generating and outputting an asynchronous clock that is not necessarily synchronized with the data recording timing;
an analog-digital converter for digitalizing the readout signal from the recording medium based on the asynchronous clock to output asynchronous data;
an offset component remover for calculating an offset component contained in the asynchronous data and removing the offset component from the asynchronous data; and
a timing detector for generating timing error information representing a timing error between the data recording timing and the asynchronous clock of the clock generator, and outputting a pseudo-synchronous clock that is synchronized or pseudo-synchronized with the data recording timing based on the timing error information, wherein the offset component remover includes:
a subtractor for subtracting the offset component calculated by the offset component remover from the asynchronous data of the analog-digital converter;
a pseudo-synchronous data generator for generating pseudo-synchronous data that is synchronized with the pseudo-synchronous clock based on the timing error information of the timing detector and the asynchronous data; and
an offset component calculator for calculating an offset component contained in the pseudo-synchronous data and outputting the calculated offset component to the subtractor, wherein:
the timing detector outputs a lock signal when a frequency and phase of the asynchronous data have been pulled in; and
the offset component remover further includes a mode selector, which selects the asynchronous data from the analog-digital converter in a beginning of an operation and thereafter selects the pseudo-synchronous data of the pseudo-synchronous data generator after receiving the lock signal of the timing detector.

2. (canceled)

3. The reproduction signal processing device of claim 1, wherein the clock generator generates and outputs a fixed-frequency clock.

4. The reproduction signal processing device of claim 1, wherein the clock generator generates an asynchronous clock whose frequency is equal to, higher than or lower than a frequency of the data recording timing contained in the readout signal.

5. The reproduction signal processing device of claim 1, wherein the asynchronous data from the analog-digital converter is a DC-free signal.

6. The reproduction signal processing device of claim 1, wherein the pseudo-synchronous data generator generates the pseudo-synchronous data by using the timing error information generated by the timing detector as phase information.

7. The reproduction signal processing device of claim 1, wherein the pseudo-synchronous data generator generates the pseudo-synchronous data by linearly interpolating two adjacent asynchronous data based on the timing error information generated by the timing detector.

8. The reproduction signal processing device of claim 1, wherein the pseudo-synchronous data generator generates the pseudo-synchronous data through a Nyquist interpolation between two adjacent asynchronous data based on the timing error information generated by the timing detector.

9. The reproduction signal processing device of claim 1, wherein the pseudo-synchronous data generator generates the pseudo-synchronous data by fixing the data to different specific values for a positive polarity and for a negative polarity based on a polarity of a sign of the asynchronous data.

10. The reproduction signal processing device of claim 6, wherein phase information, being the timing error information generated by the timing detector, is a timing error occurring between the asynchronous data and the pseudo-synchronous data.

11. The reproduction signal processing device of claim 1, wherein the readout signal read out from the recording medium is supplied via a wireless transmission path or a transmission path including an optical fiber, a coaxial cable or a power line.

12. The reproduction signal processing device of claim 1, wherein the recording medium is an optical disc including a DVD, a CD or a Blu-ray disc.

13. A video display device, comprising:
an LSI, including the reproduction signal processing device of claim 1 and a signal processing circuit for decoding a received signal including audio data and video data based on the pseudo-synchronous data from which the offset component has been removed, as obtained by the reproduction signal processing device; and
a display terminal for receiving the decoded signal from the LSI to audibly output decoded audio data and display decoded video data.
